(19) United States
(12) Patent Application Publication
(10) Pub. No.: US 2002/0184132 A1
(43) Pub. Date: Dec. 5, 2002

(54) Method for analyzing the performance of securities

(76) Inventor: Richard Foster, NYC, NY (US)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/919,910

(22) Filed: Aug. 2, 2001

Related U.S. Application Data
(60) Provisional application No. 60/295,584, filed on Jun. 5, 2001.

(51) Int. Cl. G06F 17/60

(52) U.S. Cl. 705/36

(57) ABSTRACT

A system and method for analyzing financial markets and securities. The method involves graphing the performance of a security relative to a benchmark, such as the overall market. In order to screen out anomalous performance data, the method preferably uses data based on moving or rolling averages. Statistical calculations are performed on the benchmark data in order to depict the normal range of performance for the benchmark over time.

### CROSS REFERENCE TO RELATED APPLICATION

This application claims priority to provisional application No. 60/295,584, filed Jun. 5, 2001, the entirety of which is incorporated herein by reference.

### FIELD OF INVENTION

The present invention relates to the field of market performance analysis. More particularly, the present invention relates to a method for analyzing the relative performance of securities.

### BACKGROUND

Traditional methods of visually evaluating the performance of securities, such as plotting price histories or using charting techniques like plotting the 50-day or 200-day moving averages of price data, often fail to give a clear picture of a security's performance relative to other securities or the overall market. This deficiency is important because investors are often interested in determining whether a security has historically outperformed its peers or the overall market.

To attempt to address this, there are programs that will chart, on a percentage basis, a company's equity stock performance against the performance of another security or against a market index. For example, FIG. 1 illustrates the shareholder total returns for a single company, Delta Airlines, compared to the total returns of the overall market over time. In one embodiment of the present invention the overall market is represented by the S&P 500 stock index. In another embodiment, the overall market is represented by the Wilshire 5000 stock index. In still another embodiment, the overall market is represented by the Nasdaq Composite stock index or the Nasdaq 100 stock index. In another embodiment, the overall market is represented by a Lehman bond index or some other fixed income index. When appropriate, specific industry benchmarks, such as the Philadelphia Semiconductor Index or the Philadelphia Banking Index, are used instead of an overall market benchmark. Charts like FIG. 1 may not be very instructive, however, as there may be too many seemingly random movements from which to draw meaningful conclusions.

Investors in an individual security frequently would like to know how well the security performs relative to the market. In one embodiment of the invention, relative performance means relative price performance. In a preferred embodiment, relative performance is measured using shareholder total return information. In other embodiments of the invention, relative performance is measured using other financial metrics such as median net operating profit less adjusted taxes (NOPLAT), return on invested capital (ROIC), price to earnings ratio (P/E), extracted long term cash flow growth rate, or price to earnings ratio divided by growth (PEG), for example. In other words, investors are interested in seeing the difference between the total return of the security and the total return of the market, or some other benchmark. With reference to Delta Airlines, for example, this can be done by subtracting the overall market's total return from Delta's total return. If the difference favors Delta, the line will be above zero, and if Delta's total return is less than the market's, the line will be below zero. Such a chart is displayed in FIG. 2. This method of “taking out” the effect of the market is called “renormalization.” Renormalization means taking out the effect of the overall market in order to see the “normal” pattern. Delta had some very profitable early years, but then the pattern becomes less clear, making it difficult to discern whether it really did better than the market. Similar uncertainty can arise when using existing tools to evaluate the performance of securities.

For the foregoing reasons, there is a need for a method of visually displaying industry performance relative to the overall market performance in a manner that is more intuitive and easy to understand. Likewise, there is a need for a more intuitive and understandable method of displaying company performance relative to its industry's performance, or relative to the overall market's performance.

### SUMMARY OF THE INVENTION

The present invention is directed to a system and method for analyzing equity markets and securities. The invention can also analyze fixed income markets and securities. In one embodiment, the method involves graphing the performance of a security relative to a benchmark, such as the overall market. In order to screen out anomalous performance data, the method preferably uses data based on moving or rolling averages. Furthermore, statistical calculations are performed on the benchmark data in order to depict the normal range of performance for the benchmark over time.

In one aspect of the invention, a first average return for a security and a benchmark during a first period of time, a second average return for said security and a benchmark during a second period of time, first confidence values, responsive to a confidence level, for the first average return for the benchmark during the first period of time, and second confidence values, responsive to the confidence level, for the second average return for the benchmark during the second period of time, are calculated.

In another aspect of the invention, the first average return for the security and the first confidence values are plotted as a function of the first period of time, and the second average return for the security and the second confidence values are plotted as a function of the second period of time.

In a further aspect of the invention, a first renormalized return for a security during a first period of time, a second renormalized return for the security during a second period of time, first confidence values, responsive to a confidence level, for a first average return for a benchmark during the first period of time, and second confidence values, responsive to the confidence level, for a second average return for the benchmark during the second period of time, are calculated. Furthermore, the first renormalized return for the security and the first confidence values are plotted as a function of the first period of time, and the second renormalized return for the security and the second confidence values are plotted as a function of the second period of time.

The invention makes performance patterns and trends easier to see by smoothing out otherwise discrete data points. Another advantage of the present invention is its ability to facilitate quick analyses of relative performance. The invention, for example, can be used to illustrate whether relative performance falls within a normal range. The invention can also be used to depict whether relative performance systematically falls above or below the normal range.

These and other features and advantages of the invention will be more fully understood from the following detailed description of preferred embodiments that should be read in light of the accompanying drawings.

### BRIEF DESCRIPTION OF THE DRAWINGS

The accompanying drawings, which are incorporated in and form a part of the specification, illustrate preferred embodiments of the present invention and, together with the description, serve to explain the principles of the invention.

FIG. 1 illustrates the total returns of an airline company and the overall market over time;

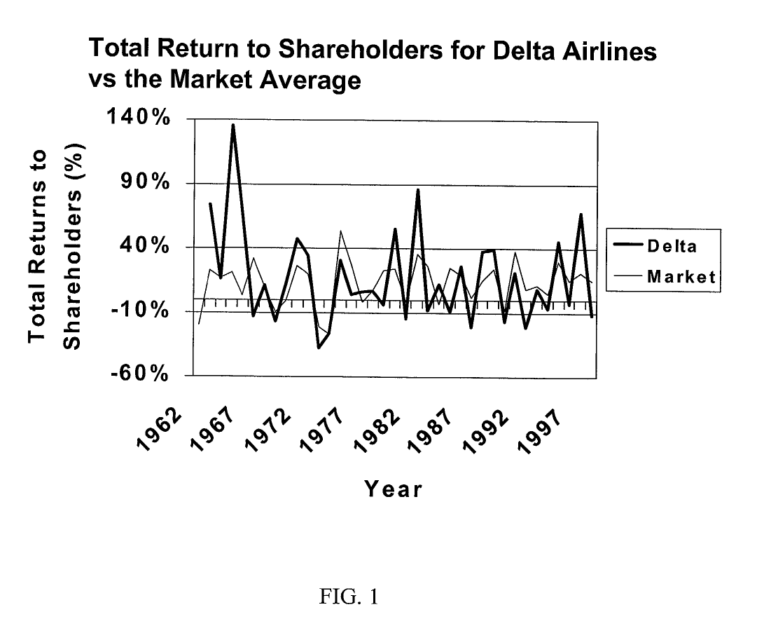

FIG. 2 illustrates the total returns of an airline minus the total returns of the overall market over time;

FIG. 3 illustrates moving geometric averages of the total returns of an airline company and the overall market over time;

FIG. 4 illustrates the moving geometric averages of the total returns of an airline minus the moving geometric averages of the total returns of the overall market over time;

FIG. 5 illustrates the moving geometric averages of the total returns of the airline industry minus the moving geometric averages of the total returns of the overall market over time;

FIG. 6 illustrates the moving geometric averages of the total returns of an airline minus the moving geometric averages of the total returns of the airlines industry over time;

FIG. 7 illustrates the total returns over time of multiple airline companies;

FIG. 8 illustrates an embodiment of the present invention that displays the performance of one airline relative to the airlines industry over time;

FIG. 9 illustrates the total returns over time of multiple industry categories;

FIG. 10 illustrates an embodiment of the present invention that displays the performance of the airlines industry relative to the overall market over time;

FIG. 11 illustrates a preferred embodiment of the present invention that displays the performance of the airlines industry relative to the overall market over time;

FIG. 12 illustrates a preferred embodiment of the present invention that displays the performance of one airline relative to the airlines industry over time; and

FIG. 13 illustrates a computer system embodiment of the present invention.

### DETAILED DESCRIPTION

In describing embodiments of the invention, specific terminology will be used for the sake of clarity. However, the invention is not intended to be limited to the specific terms so selected, and it is to be understood that each specific term includes all equivalents.

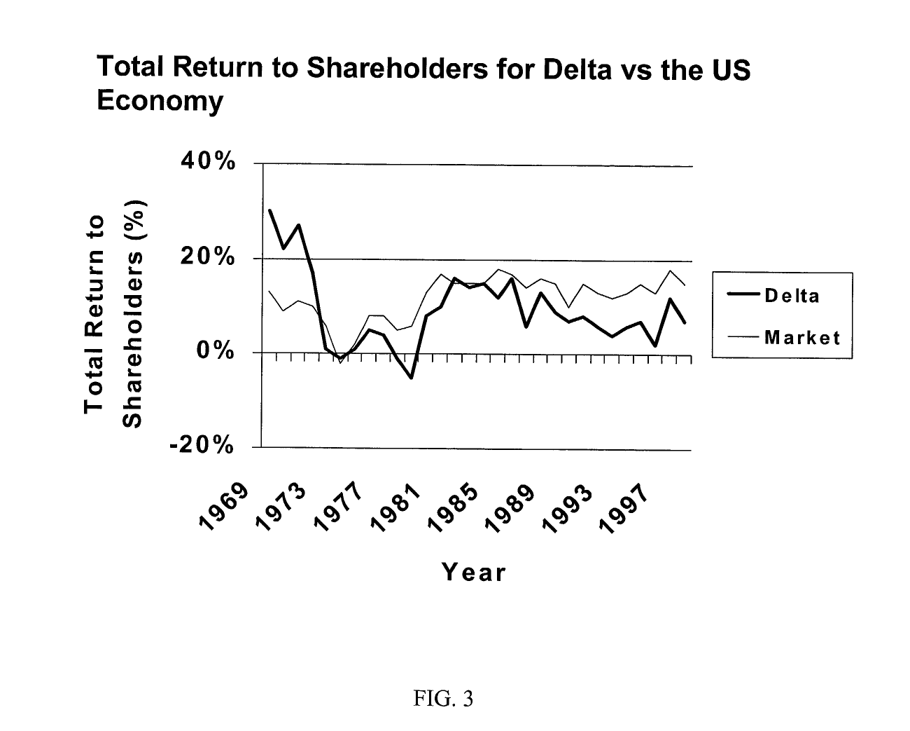

With reference to the drawings, in general, and FIGS. 3 through 12 in particular, embodiments of the present invention are described.

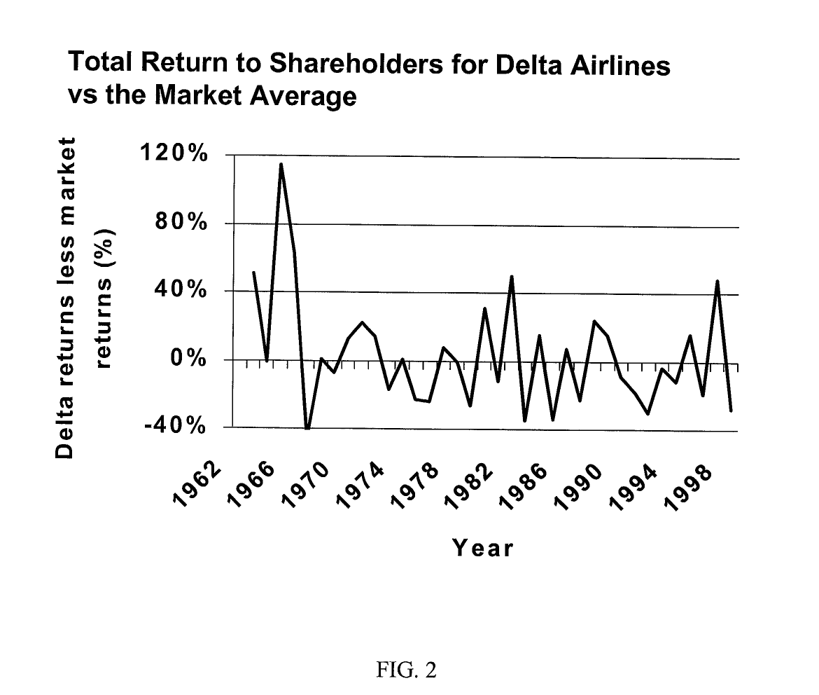

In preparing a chart like FIG. 2, extreme data points and anomalies should be smoothed out. One way to do this is to look at long-term averages. From the pattern of the chart in FIG. 2, it appears that the total returns to shareholders seem to run in three to four year cycles. In preferred embodiments, the invention evaluates the average total return over at least two cycles. In a preferred embodiment, the invention evaluates seven-year moving average total returns. In a preferred embodiment, the data point representing the average total return of a particular year is computed by calculating the average of the total returns for that year and each of the three preceding and three succeeding years. In other words, in such an embodiment, the total return for 1990 would be determined by calculating averaging annual total return from 1987 through 1993. In one embodiment, the moving average is an arithmetic average. In a more preferred embodiment, the moving average is a geometric mean of the formula: ^{n\sqrt{a1^{*} . . . ^{*}an−1^{*}an}}

where n is the number of data points. In a preferred embodiment, data on a yearly basis is used to calculate annual total returns. In another preferred embodiment, data on a monthly basis is used to calculate annual total returns.

In a preferred embodiment, total return data is represented by adding 100% to the raw percentage return for this geometric mean calculation. For example, for a given year, a total return of 15% is represented by the value 0.15. One hundred percent is then added to this total return resulting in a total value of 1.15 for that year. This total return value is then multiplied by the total return values calculated for the other n−1 years, and the nth root of the aggregate figure is calculated to determine the geometric mean. One hundred percent is then subtracted from this geometric mean in order to calculate the average total return for the given time period. For example, if the geometric mean is 1.12, 100% is subtracted from this value resulting in an average total return of 0.12, or 12%.

FIG. 3 illustrates a comparison of the seven-year Delta average total returns to the seven-year overall market average total returns. The pattern is comparatively flat, suggesting that the averaging process has taken out the bumps. As depicted in FIG. 3, the long term average total returns to Delta shareholders is about 12%-14%, with lower levels in the 1970s and higher levels in the 1980s and 1990s. FIG. 3 indicates that Delta's returns were a bit above the overall market in the '60s, but then fell behind and remained behind the overall market.

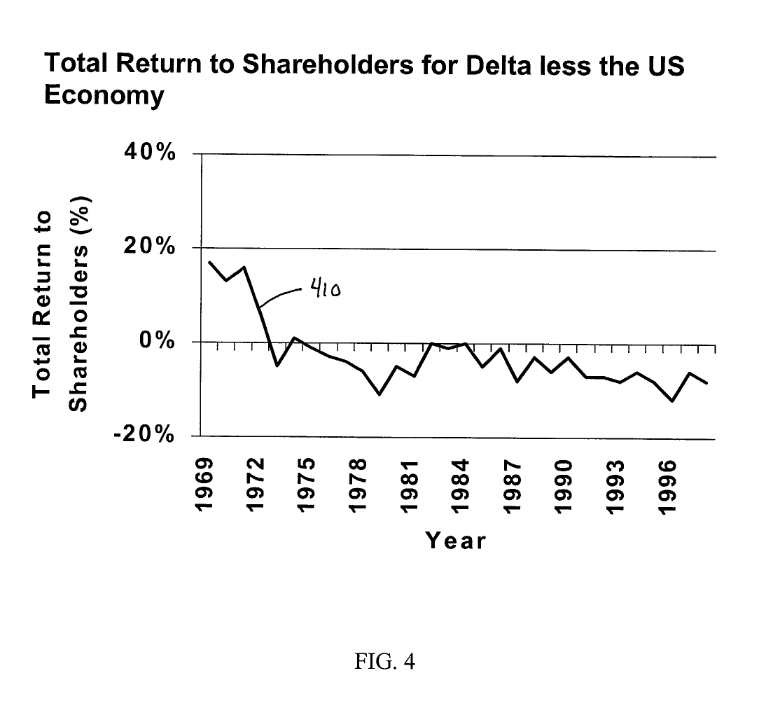

FIG. 4 simplifies FIG. 3 by illustrating the difference between Delta and the overall market. In FIG. 4, the seven-year average total returns of the overall market is subtracted from Delta's seven-year average total returns (renormalizing). The difference is represented by line 410 in FIG. 4. Again, if line 410 is above zero, according to this depiction, Delta did better than the overall market; if line 410 is below zero, Delta performed worse than the overall market. From historical information, an investor, for example, would know that there was an inflation spike in the early 1970s. FIG. 4 indicates that, since then, Delta has had a harder time providing total returns for its shareholders that surpassed the overall market.

An investor, for example, could also be interested in why Delta had these difficulties. An obvious possibility is that the airlines industry as a whole underperformed the overall market. Perhaps this was because the regulated airlines industry was dependent on soaring fuel prices. Accordingly, the present invention also includes an examination of the performance of the relevant industries.

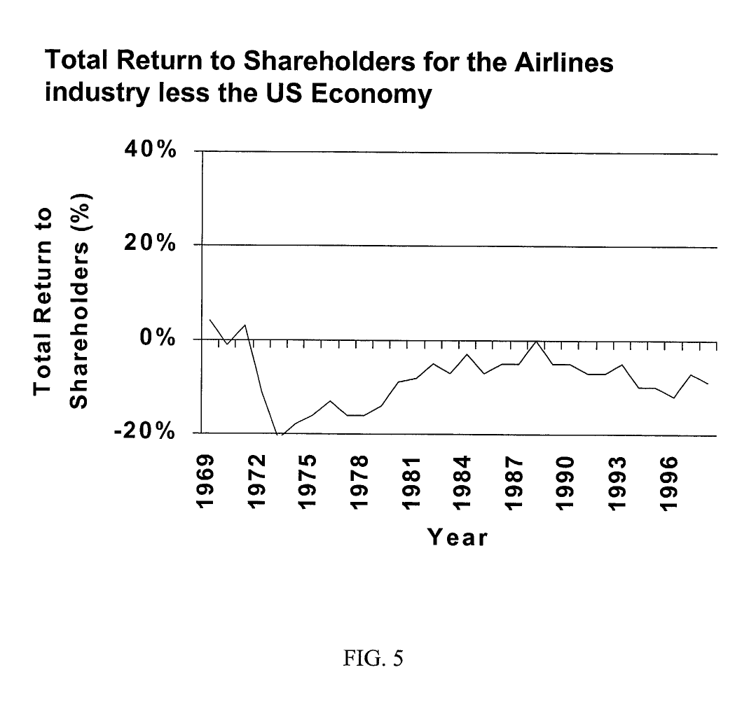

FIG. 5 illustrates the average total returns for the airlines industry relative to the overall market. FIG. 5 is derived by substituting the seven-year average total return data of Delta in FIG. 4 with the seven-year average total return data of the overall airlines industry, for the relevant time period. The data for the airline industry may be represented, for example, by the S&P transportation sector, the Dow Jones transportation index, or a capitalization-weighted average of all the publicly held airline companies.

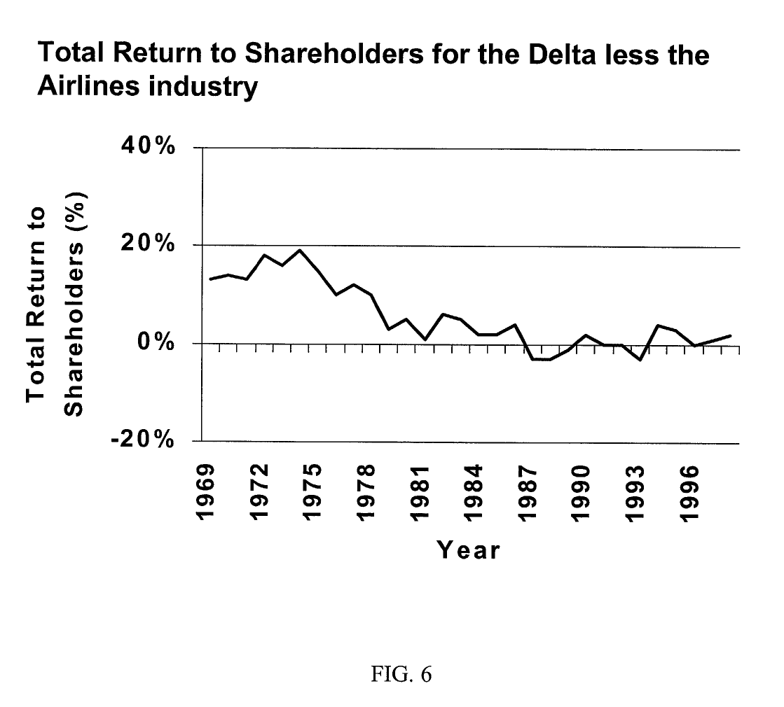

FIG. 5 illustrates that, for the relevant time period, the airlines industry as a whole performed worse than the overall market. Together, FIGS. 4 and 5 do not indicate whether Delta's performance was a result of Delta's management, or was the result of the “structure” of the entire airlines industry. FIG. 6 addresses this by subtracting the airline industry's performance from Delta's performance.

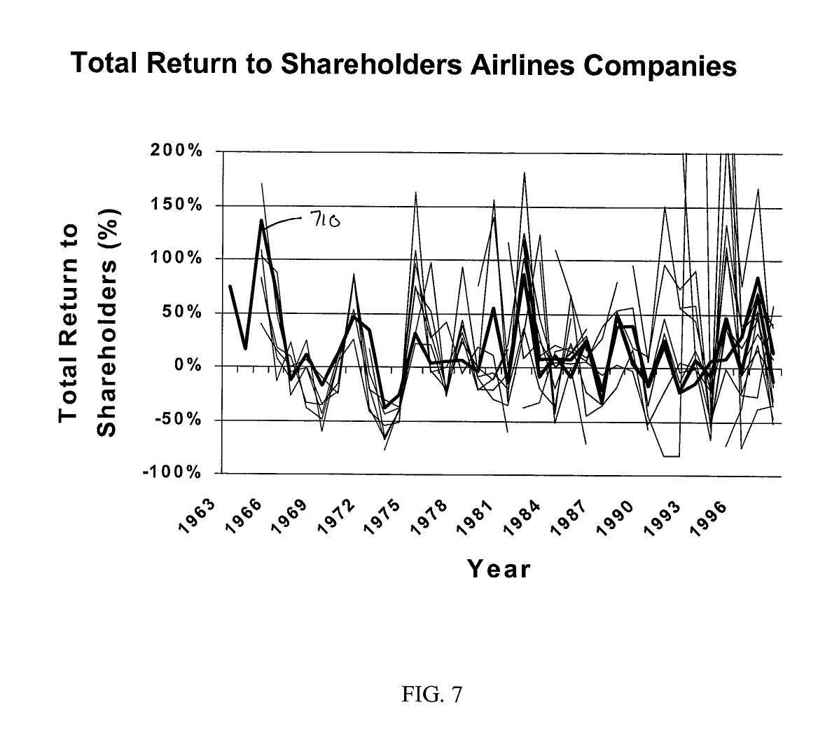

While FIG. 6 addresses Delta's performance relative to the industry, it does not fully address the question of whether Delta's performance can meaningfully be characterized as “normal,” especially in an industry such as the airlines industry that has a wide range of performance by individual companies. This wide range is illustrated in FIG. 7, where Delta is represented by the bold line 710.

These questions can be answered by invoking a test that statisticians developed to address the question of what is “normal”. Statisticians developed a measure called the “confidence” limit. “Confidence” measures the likelihood that the average performance falls within a given range of values. In preferred embodiments, this confidence band is calculated using the following formula

$$x \pm z [ \frac{σ}{\sqrt{n}} ]$$

where x is the average of the data points, n is the number of data points, σ is the standard deviation of the data points, and z, which is a well-known statistical variable, is the number of standard deviations required to encompass the desired confidence level.

Since business people are typically comfortable with 90% confidence or even less, in a preferred embodiment of the present invention, the desired confidence level is set at 90%.

In a preferred embodiment, the data points used to calculate the confidence band are the seven-year moving averages of total return information for a given industry or for the overall market.

For a given industry, a wide confidence band represents a wide range of performance for that industry. The “confidence” band represents the “normal” range of performance. In other words, one can be “confident” that, if a company's performance is outside of an industry's confidence band, it is very unlikely that the company's performance is considered “normal.” The range of “normal” results is called the “Normal Performance Band.”

Based on raw total return data, the confidence limit for the airlines industry is observed to be about 20%. That is to say, the “normal” range of performance in the airlines industry is the average performance plus or minus 20% or 2000 basis points. Among investors, this would be considered a very wide range, reflecting the wide range of conditions within the airline market.

When seven-year moving averages are used, this wide range shrinks to about 8% or 800 basis points. Thus, if Delta's returns are more than 8% above the industry average, they could be characterized as reflecting abnormally good performance, or “outperformance.” Results more than 8% below than the market average could be characterized as abnormally bad performance, or “underpeformance.”

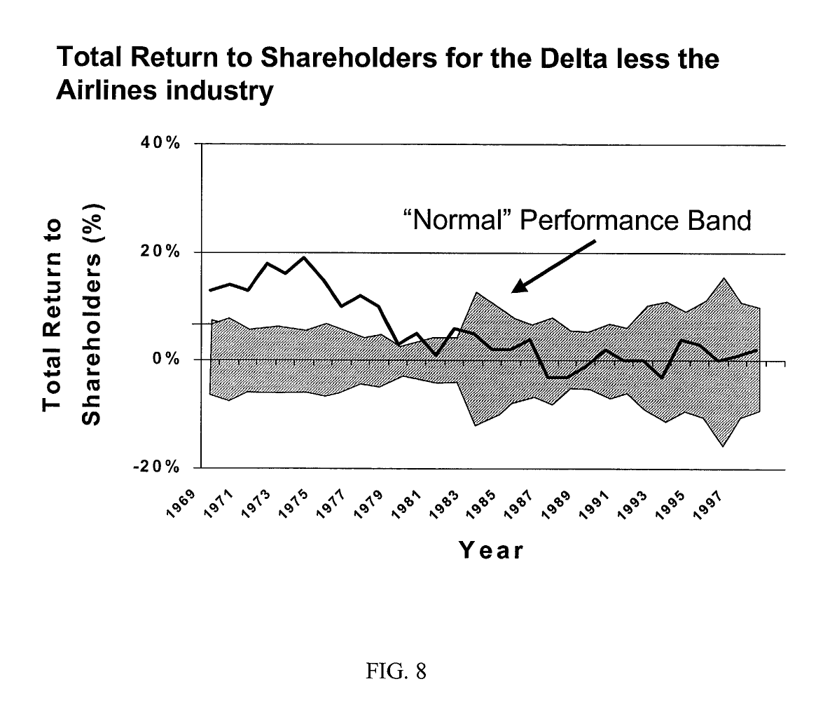

As illustrated by FIG. 8, the normal performance range for the airlines industry was reasonably constant and narrow at about 6% in the 1960s and early 1970s. The normal performance range expanded in the early 1980s (which coincided with deregulation), and by the early 1990s, the expansion was proceeding steadily. That is, the range of “normal” performance for the industry expanded as a consequence of changes in the industry structure.

FIG. 8 depicts these results graphically to visualize how well Delta performed relative to the “normal” performance range of the airlines industry. Thus, the average industry performance on this relative chart is set at zero percent. The shaded area represents the normal range of industry performance at a 90% confidence level. Because confidence measures a range around an average, the shaded area straddles zero percent. The line measuring Delta's relative performance is plotted by subtracting the seven-year moving average total returns for the overall market from the seven-year moving average total returns for Delta.

The result is clearly apparent. According to these depictions, Delta in the 1960s and 1970s “outperformed” the airlines industry. In the early 1980s, Delta's performance began to approach the average of the airlines industry. Since then, Delta's performance has been “normal.”

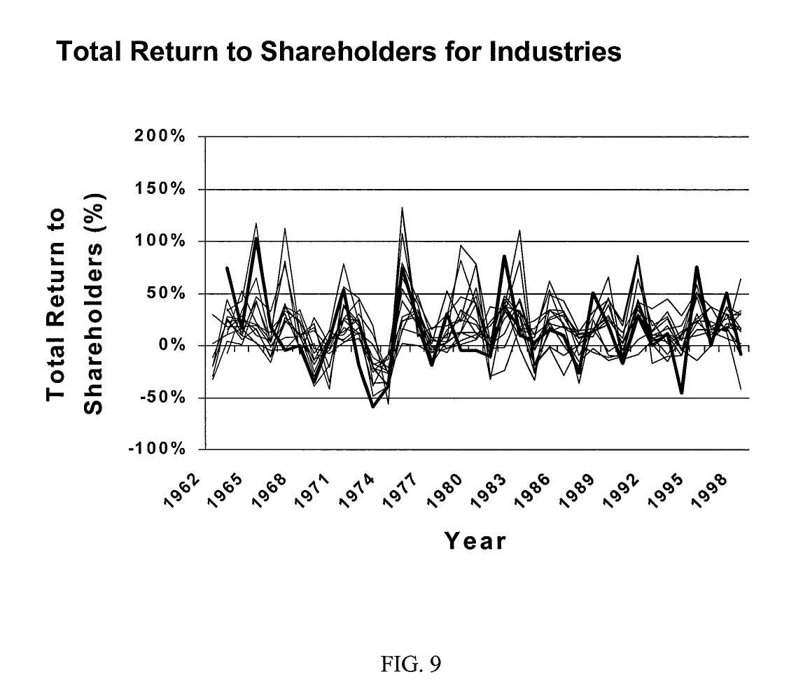

Accordingly, it would appear that Delta's underperformance of the overall market is a result of the underperformance of the airlines industry as a whole. Nevertheless, a remaining question is whether the airlines industry “significantly” underperformed the overall market. This issue can be approached in much the same way as the determination of whether Delta underperformed the airlines industry—by establishing the “normal” range of the overall market and plotting the performance of the airlines industry relative to the market. As shown in FIG. 9, there is a wide dispersion of performance among industries within the overall market. Each industry has its own performance pattern, although there are clearly patterns for the overall market as a whole.

Applying the approach developed above, the normal performance range for the overall market, on an annual basis, can be calculated to be about 10%, much less than the normal performance range within the airlines industry. Using a seven-year moving average of the performance of the overall market, the normal performance range shrinks dramatically to about the average plus or minus 3%. Therefore, if the renormalized total return of an industry is less than 3% above or below the market average, the result can be characterized as being within the normal range.

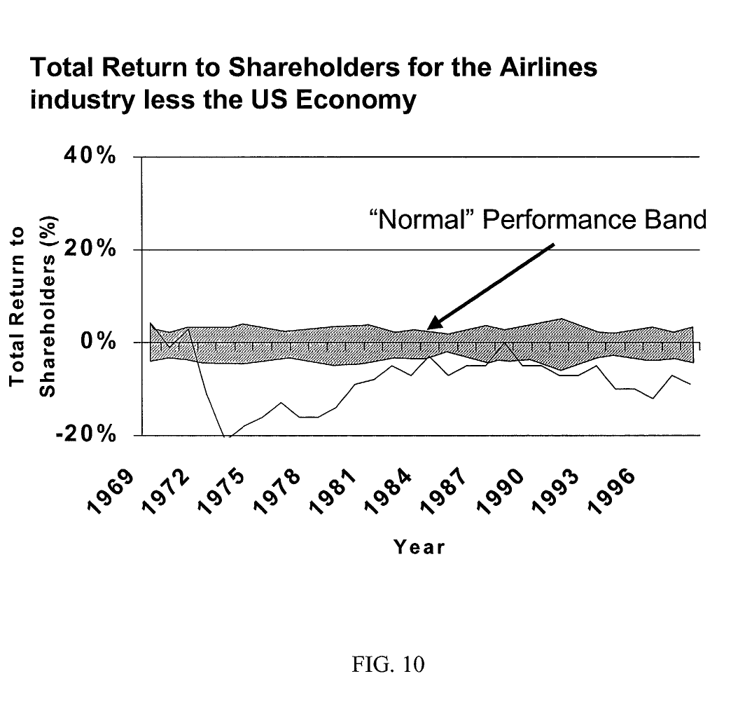

FIG. 10 illustrates the total return performance of the airlines industry relative to the overall market from 1969 until 1997. As in FIG. 8, the industry's total return, as depicted in FIG. 10, is measured by subtracting the seven-year moving average total returns of the overall market from the seven-year moving average total returns of the industry. According to the depiction of FIG. 10, it is apparent that the airlines industry significantly underperformed the overall market for virtually the entire period examined.

To an investor, for example, these analyses indicate that the airlines industry underperformed the overall market by such a large margin that Delta itself became an underperformer in the market. Delta was a victim of the general condition of the airlines industry, rather than of any deficiencies in managerial skills. This could also suggest that the majority of Delta's shortfall should not be laid at the feet of Delta's management, except in so far as one could reasonably expect Delta's management to outperform its industry over a sustained period. It appears that Delta's management was able to do that in the '60s and '70s, but not since then. Nevertheless, performing at the industry average is quite different from performing below the industry average. If that were the case, one might easily fault Delta's management. But that is not the case. According to the analysis described above, Delta's management appears to have been about average for its industry.

In principle, the method described above can be used to analyze all companies and all industries in the U.S. economy. The difficulty is that each industry can be expected to have its own “normal” range of performance and its own characteristics. In order to compensate for this, in the preferred embodiments, the method of the present invention standardizes charts for industries and companies by assigning average benchmark performance a value of 50%. Furthermore, in preferred embodiments, the “normal” range for a benchmark is designated to be plus or minus 50% from the average performance value. This means, in such embodiments, that the normal range has values between 0% and 100%, which makes the charts easy to read and compare from industry to industry.

In a preferred embodiment of the present invention, the following formula is used to calculate industry performance for standardized charts displaying industry performance versus the overall market:

$$0.5 + ( 0.5 * \frac{( I n d u s t r y - M a r k e t )}{C o n f i d e n c e} )$$

where Industry is the seven-year average industry total return, Market is the seven-year average market total return, and Confidence is

$$z ( \frac{σ}{\sqrt{n}} ) ,$$

as previously described. When appropriate, the seven-year average total return for a single security can be substituted for Industry, and Industry can be substituted for Market.

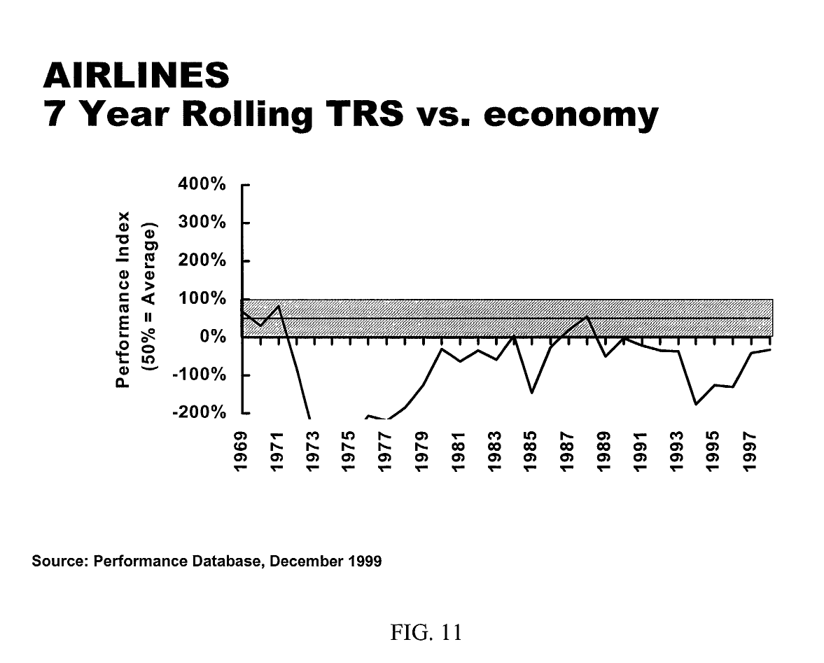

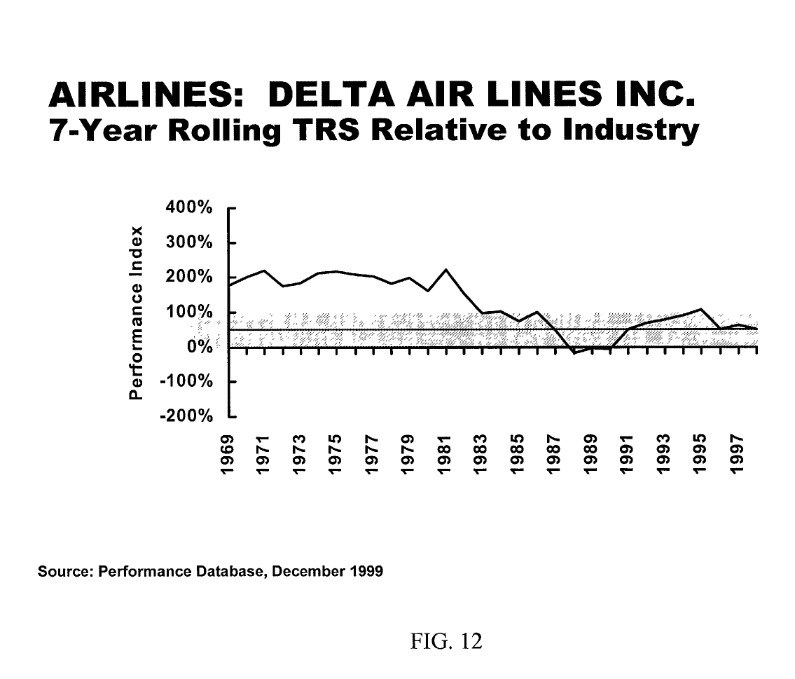

For example, FIG. 11 is a “Performance Chart” for the airlines industry relative to the overall market from 1969 until 1997. FIG. 12 illustrates the Performance Chart for Delta Airlines relative to the airlines industry for these years.

In preferred embodiments of the present invention, the Performance Charts can depict the total return of any industry relative to the market, or any company relative to its industry, and enable quick analysis of how well it performed on a sustained basis. If the total return is above the shaded area, one could be confident that something exceptional is happening for the better. If the total return is below the shaded area, one could be confident that something unfavorable is happening. Within the shaded area, one could conclude that “normal” processes are at work. Thus, an advantage of the present invention is that the clutter and noise that otherwise make interpretation difficult, if not impossible, have been removed.

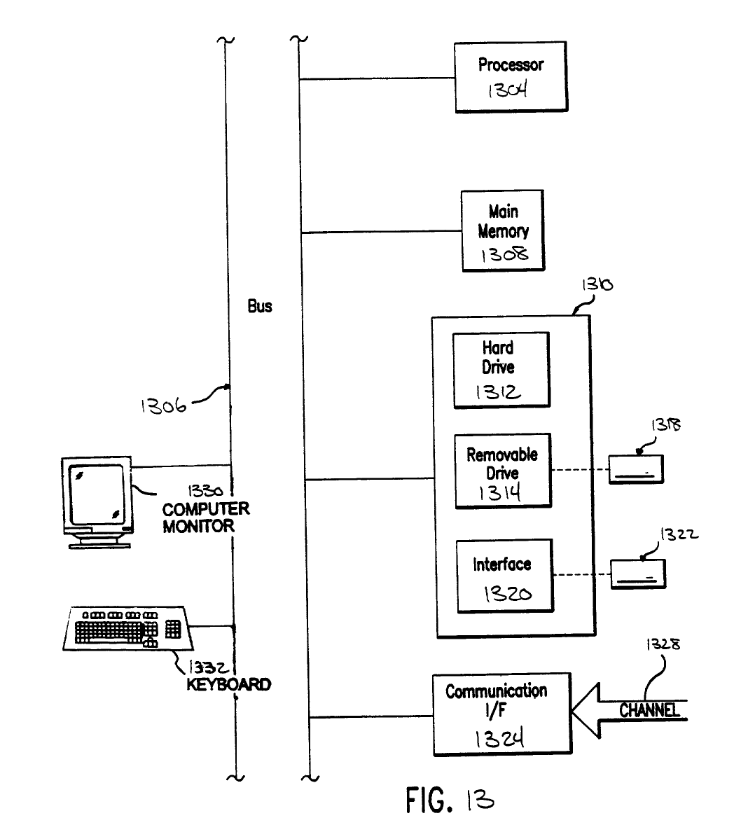

In another embodiment, the present invention may be implemented in a computer system as shown in FIG. 13. The computer system includes one or more processors, such as a processor 1304. The processor 1304 is connected to a communication bus 1306 and performs the calculating functions of the invention. Various software embodiments are described in terms of this exemplary computer system. After reading this description, it will be apparent to a person skilled in the relevant art how to implement the invention using other computer systems and/or computer architectures.

The computer system depicted in FIG. 13 also includes a main memory 1308, preferably random access memory (RAM), and can also include a secondary memory 1310. The secondary memory 1310 can include, for example, a hard disk drive 1312 and/or a removable storage drive 1314, representing a floppy disk drive, a magnetic tape drive, an optical disk drive, or other similar devices known in the art The removable storage drive 1314 reads from and/or writes to a removable storage unit 1318 in a manner know in the art. The removable storage unit 1318, represents a floppy disk, magnetic tape, optical disk, or other similar medium known in the art, which is read by and written to by the removable storage drive 1314. As will be appreciated, the removable storage unit 1318 includes a computer usable storage medium having stored therein computer software and/or data.

In other embodiments, the secondary memory 1310 may include other similar means for allowing computer programs or other instructions to be loaded into the computer system. Such means can include, for example, a removable storage unit 1322 and an interface 1320. Examples of such means can include a program cartridge and cartridge interface (such as that found in video game devices), a removable memory chip (such as an EPROM, or PROM) and associated socket, and other removable storage units 1322 and interfaces 1320 known in the art which allow software and data to be transferred from the removable storage unit 1322 to the computer system.

The computer system can also include a communications interface 1324. The communications interface 1324 allows software and data to be transferred between the computer system and external devices. Examples of the communications interface 1324 can include a modem, a network interface (such as an Ethernet card), a communications port, a PCMCIA slot and card, and other similar devices known in the art. Software and data transferred via the communications interface 1324 are in the form of signals that can be electronic, electromagnetic, optical or other signals capable of being received by the communications interface 1324. Signals are provided to communications interface via a channel 1328. Channel 1328 carries signals and can be implemented using wire or cable, fiber optics, a phone line, a cellular phone link, an RF link and other communications channels.

The computer system also includes a monitor 1330 and a keyboard 1332 for users to interface with the system. Users can utilize keyboard 1332 to enter or edit financial data and to choose a desired confidence level. Monitor 1330 can be used to visually display the resulting graphs of the invention.

In this document, the terms “computer program medium” and “computer usable medium” are used to generally refer to media such as the removable storage device 1318, a hard disk installed in hard disk drive 1312, and signals received via the communications interface. These computer program products are means for providing software to the computer system.

In embodiments of the present invention, computer programs (also called computer control logic) are stored in the main memory 1308 and/or the secondary memory 1310. Computer programs can also be received via the communications interface 1324. Such computer programs, when executed, enable the computer system to perform the features of the present invention as discussed herein. In particular, the computer programs, when executed, enable the processor 1304 to perform the features of the present invention. Accordingly, such computer programs represent controllers of the computer system.

In an embodiment where the invention is implemented using software, the software may be stored in a computer program product and loaded into the computer system using the removable storage drive 1314, the hard drive 1312 or the communications interface 1324. The control logic (software), when executed by the processor 1304, causes the processor 1304 to perform the functions of the invention as described herein.

In another embodiment, the invention is implemented primarily in hardware using, for example, hardware components such as application specific integrated circuits (ASICs). Implementation of such a hardware state machine so as to perform the functions described herein will be apparent to persons skilled in the relevant art(s).

In yet another embodiment, the invention is implemented using a combination of both hardware and software.

Using an embodiment of the computer system of the present invention, a user can select various options to generate the results of using the present invention. For example, the user may input financial data into the computer system with keyboard 1332. Financial data can also be entered into the computer system using removable storage drive 1314, interface 1320, or communications interface 1324, for example, from commercial electronic databases or other information services as known in the art. The financial data can be stored, for example, on hard drive 1312 or on the removable storage units 1318 or 1322. The financial data may also be stored outside of the computer system and transmitted to the system through communications interface 1324 when needed. Calculations to be performed on the financial data according to the present invention can be performed in the computer program or software previously described, as known in the art.

A user of a computer system embodying the present invention can use keyboard 1332 provide inputs to and review outputs of the system. For example, a user could use keyboard 1332 to select a confidence level to apply to the calculations of the invention. The user may also select the security and benchmark to analyze as well as the time period for the analysis. The user may use keyboard 1332 to select the type of financial data to use for performance analysis. The user can also use keyboard 1332 to increase or decrease the number of data points used to calculate the moving averages according to the present invention.

In embodiments of the present invention, after the user makes these selections, processor 1304 of the computer system uses the financial data and the computer program stored in main memory 1308 and/or secondary memory 1310 to perform the calculations necessary to generate results, including for example, graphs of the invention. In one embodiment, the financial data and software program may be stored outside of the computer system and transmitted to the system through communications interface 1324 in order to perform the calculations of the invention. The results of the method of the present invention. for example performance graphs, can be displayed on monitor 1330 and can also be sent to a printer, not shown, connected to the computer system or other output device, as known in the art.

While there have been shown and described specific embodiments of the present invention, it should be apparent to those skilled in the art that various changes and modifications may be made without departing from the scope of the invention or its equivalents. The invention is intended to be broadly protected consistent with the spirit and scope of this disclosure.

What is claimed is:

1. A method for analyzing financial securities comprising:
calculating a first average return for a security during a first period of time;
calculating a second average return for said security during a second period of time;
calculating a first average return for a benchmark during said first period of time;
calculating a second average return for said benchmark during said second period of time;
choosing a confidence level;
calculating first confidence values, responsive to the confidence level, for the first average return for said benchmark during said first period of time; and
calculating second confidence values, responsive to the confidence level, for the second average return for said benchmark during said second period of time.

2. The method of claim 1 further comprising:
plotting said first average return for said security as a function of said first period of time;
plotting said second average return for said security as a function of said second period of time;
plotting said first confidence values as a function of said first period of time; and
plotting said second confidence values as a function of said second period of time.

3. The method of claim 1 further comprising:
plotting said first average return for said security as a function of said first period of time;
plotting said second average return for said security as a function of said second period of time;
plotting said first confidence values as a function of said first period of time and said first average return for the benchmark; and
plotting said second confidence values as a function of said second period of time and said second average return for the benchmark.

4. The method of claim 1 wherein the first and second average returns for the security and the first and second average returns for the benchmark are averages of annual total returns in percentages.

5. The method of claim 1 wherein the first and second average returns for the security and the first and second average returns for the benchmark are averages price returns in percentages.

6. The method of claim 1 wherein the first and second average returns for the security and the first and second average returns for the benchmark are averages of annualized monthly total returns in percentages.

7. The method of claim 1 wherein the first and second average returns for the security and the first and second average returns for the benchmark are averages of annualized monthly price returns in percentages.

8. The method of claim 1 wherein the first and second average returns for the security and the first and second average returns for the benchmark are averages of a financial measurement.

9. The method of claim 8 wherein the financial measurement is median net operating profit less adjusted taxes (NOPLAT).

10. The method of claim 8 wherein the financial measurement is return on invested capital (ROIC).

11. The method of claim 8 wherein the financial measurement is price to earnings ratio (P/E).

12. The method of claim 8 wherein the financial measurement is extracted long term cash flow growth rate.

13. The method of claim 8 wherein the financial measurement is price to earnings ratio divided by growth (PEG).

14. The method of claim 1 wherein the first and second average returns for the security and the first and second average returns for the benchmark are calculated by calculating geometric averages of the returns.

15. The method of claim 1 wherein the first and second average returns for the security and the first and second average returns for the benchmark are calculated by calculating arithmetic averages of the returns.

16. The method of claim 1 wherein the security is an industry benchmark.

17. The method of claim 1 wherein the security is an equity security.

18. The method of claim 1 wherein the security is a fixed income security.

19. The method of claim 1 wherein the benchmark is an industry benchmark.

20. The method of claim 1 wherein the benchmark is a market index.

21. The method of claim 1 wherein the benchmark is a measurement of the economy.

22. The method of claim 1 wherein the first and second periods of time are each at least three years.

23. The method of claim 22 wherein the first and second periods of time are each seven years.

24. The method of claim 1 wherein the first and second periods of time are each at least two industry cycles.

25. The method of claim 1 wherein the first and second periods of time are each at least two economic cycles.

26. A method for analyzing financial securities comprising:
calculating a first average return for a security during a first period of time;
calculating a second average return for said security during a second period of time;
calculating a first average return for a benchmark during said first period of time;
calculating a second average return for said benchmark during said second period of time;
calculating a first renormalized return for said first period of time responsive to said first average returns for the security and for the benchmark during said first period of time;
calculating a second renormalized return for said second period of time responsive to said second average returns for the security and for the benchmark during said second period of time;
choosing a confidence level;
calculating first confidence values, responsive to the confidence level, for the first average return for said benchmark during said first period of time; and
calculating second confidence values, responsive to the confidence level, for the second average return for said benchmark during said second period of time.

27. The method of claim 26 further comprising:
plotting said first renormalized return as a function of said first period of time;
plotting said second renormalized return as a function of said second period of time;
plotting said first confidence values as a function of said first period of time; and
plotting said second confidence values as a function of said second period of time.

28. The method of claim 26 wherein the first and second average returns for the security and the first and second average returns for the benchmark are averages of annual total returns in percentages.

29. The method of claim 26 wherein the first and second average returns for the security and the first and second average returns for the benchmark are averages price returns in percentages.

30. The method of claim 26 wherein the first and second average returns for the security and the first and second average returns for the benchmark are averages of annualized monthly total returns in percentages.

31. The method of claim 26 wherein the first and second average returns for the security and the first and second average returns for the benchmark are averages of annualized monthly price returns in percentages.

32. The method of claim 26 wherein the first and second average returns for the security and the first and second average returns for the benchmark are averages of a financial measurement.

33. The method of claim 32 wherein the financial measurement is median net operating profit less adjusted taxes (NOPLAT).

34. The method of claim 32 wherein the financial measurement is return on invested capital (ROIC).

35. The method of claim 32 wherein the financial measurement is price to earnings ratio (P/E).

36. The method of claim 32 wherein the financial measurement is extracted long term cash flow growth rate.

37. The method of claim 32 wherein the financial measurement is price to earnings ratio divided by growth (PEG).

38. The method of claim 26 wherein the first and second average returns for the security and the first and second average returns for the benchmark are calculated by calculating geometric averages of the returns.

39. The method of claim 26 wherein the first and second average returns for the security and the first and second average returns for the benchmark are calculated by calculating arithmetic averages of the returns.

40. The method of claim 26 wherein the security is an industry benchmark.

41. The method of claim 26 wherein the security is an equity security.

42. The method of claim 26 wherein the security is a fixed income security.

43. The method of claim 26 wherein the benchmark is an industry benchmark.

44. The method of claim 26 wherein the benchmark is a market index.

45. The method of claim 26 wherein the benchmark is a measurement of the economy.

46. The method of claim 26 wherein the first and second periods of time are each at least three years.

47. The method of claim 46 wherein the first and second periods of time are each seven years.

48. The method of claim 26 wherein the first and second periods of time are each at least two industry cycles.

49. The method of claim 26 wherein the first and second periods of time are each at least two economic cycles.

50. A method for analyzing financial securities comprising:
calculating a first average return for a security during a first period of time;
calculating a second average return for said security during a second period of time;
calculating a first average return for a benchmark during said first period of time;
calculating a second average return for said benchmark during said second period of time;
calculating a first renormalized return for said first period of time responsive to said first average returns for the security and for the benchmark during said first period of time;
calculating a second renormalized return for said second period of time responsive to said second average returns for the security and for the benchmark during said second period of time;
choosing a confidence level;
calculating first confidence values, responsive to the confidence level, for the first average return for said benchmark during said first period of time;
calculating second confidence values, responsive to the confidence level, for the second average return for said benchmark during said second period of time;
calculating a first quotient as a function of the first renormalized return and the first confidence values;
calculating a second quotient as a function of the second renormalized return and the second confidence values;
calculating a first product by multiplying the first quotient by 50%; and
calculating a second product by multiplying the second quotient by 50%.

51. The method of claim 50 further comprising:
plotting said first product as a function of said first period of time; and
plotting said second product as a function of said second period of time.

52. The method of claim 50 further comprising:
calculating a first standardized performance value by adding 50% to the first product; and
calculating a second standardized performance value by adding 50% to the second product.

53. The method of claim 50 further comprising:
plotting said first standardized performance value as a function of said first period of time; and
plotting said second standardized performance value as a function of said second period of time.

54. The method of claim 50 wherein the first and second average returns for the security and the first and second average returns for the benchmark are averages of annual total returns in percentages.

55. The method of claim 50 wherein the first and second average returns for the security and the first and second average returns for the benchmark are averages price returns in percentages.

56. The method of claim 50 wherein the first and second average returns for the security and the first and second average returns for the benchmark are averages of annualized monthly total returns in percentages.

57. The method of claim 50 wherein the first and second average returns for the security and the first and second average returns for the benchmark are averages of annualized monthly price returns in percentages.

58. The method of claim 50 wherein the first and second average returns for the security and the first and second average returns for the benchmark are averages of a financial measurement.

59. The method of claim 58 wherein the financial measurement is median net operating profit less adjusted taxes (NOPLAT).

60. The method of claim 58 wherein the financial measurement is return on invested capital (ROIC).

61. The method of claim 58 wherein the financial measurement is price to earnings ratio (P/E).

62. The method of claim 58 wherein the financial measurement is extracted long term cash flow growth rate.

63. The method of claim 58 wherein the financial measurement is price to earnings ratio divided by growth (PEG).

64. The method of claim 50 wherein the first and second average returns for the security and the first and second average returns for the benchmark are calculated by calculating geometric averages of the returns.

65. The method of claim 50 wherein the first and second average returns for the security and the first and second average returns for the benchmark are calculated by calculating arithmetic averages of the returns.

66. The method of claim 50 wherein the security is an industry benchmark.

67. The method of claim 50 wherein the security is an equity security.

68. The method of claim 50 wherein the security is a fixed income security.

69. The method of claim 50 wherein the benchmark is an industry benchmark.

70. The method of claim 50 wherein the benchmark is a market index.

71. The method of claim 50 wherein the benchmark is a measurement of the economy.

72. The method of claim 50 wherein the first and second periods of time are each at least three years.

73. The method of claim 72 wherein the first and second periods of time are each seven years.

74. The method of claim 50 wherein the first and second periods of time are each at least two industry cycles.

75. The method of claim 50 wherein the first and second periods of time are each at least two economic cycles.

76. A computer system to facilitate analyzing financial securities comprising:
a processor for calculating
a first average return for a security during a first period of time,
a second average return for said security during a second period of time,
a first average return for a benchmark during said first period of time,
a second average return for said benchmark during said second period of time,
first confidence values, responsive to a confidence level, for the first average return for said benchmark during said first period of time, and
second confidence values, responsive to the confidence level, for the second average return for said benchmark during said second period of time; and
memory for enabling the processor to store financial and user-inputted information;

77. The computer system of claim 76 further comprising
a display for plotting
the first average return for a security during the first period of time,
the second average return for said security during the second period of time,
the first confidence values during said first period of time, and
the second confidence values during said second period of time.

78. A computer system to facilitate analyzing financial securities comprising:
a processor means for calculating
a first average return for a security during a first period of time,
a second average return for said security during a second period of time,
a first average return for a benchmark during said first period of time,
a second average return for said benchmark during said second period of time,
first confidence values, responsive to a confidence level, for the first average return for said benchmark during said first period of time, and
second confidence values, responsive to the confidence level, for the second average return for said benchmark during said second period of time; and
memory means for enabling the processor to store financial and user-inputted information;

79. The computer system of claim 76 further comprising
a display means for plotting
the first average return for a security during the first period of time,
the second average return for said security during the second period of time,
the first confidence values during said first period of time, and
the second confidence values during said second period of time.

80. A computer program product comprising a computer usable medium having computer program logic recorded thereon for instructing a computer system to
receive financial and use-inputted information;
store the financial and use-inputted information;
calculate
a first average return for a security during a first period of time,
a second average return for said security during a second period of time,
a first average return for a benchmark during said first period of time,
a second average return for said benchmark during said second period of time,
first confidence values, responsive to a confidence level, for the first average return for said benchmark during said first period of time, and
second confidence values, responsive to the confidence level, for the second average return for said benchmark during said second period of time; and
display results.
